(19) United States
(12) Patent Application Publication
(10) Pub. No.: US 2024/0250747 A1
(43) Pub. Date: Jul. 25, 2024

(54) TRANSMISSION OF REFERENCE SIGNALS VIA A META-SURFACE

(71) Applicant: Telefonaktiebolaget LM Ericsson (publ), Stockholm (SE)

(72) Inventors: Jingya LI, Göteborg (SE); Behrooz MAKKI, Pixbo (SE); Henrik SAHLIN, Mölnlycke (SE)

(73) Assignee: Telefonaktiebolaget LM Ericsson (publ), Stockholm (SE)

(21) Appl. No.: 18/578,187

(22) PCT Filed: Jul. 12, 2021
(86) PCT No.: PCT/EP2021/069379

§ 371 Date: Jan. 10, 2024

(51) Int. Cl. H04B 7/155; H04L 5/00

(52) U.S. Cl. CPC H04B 7/15528; H04L 5/0048

(57) ABSTRACT

There is provided mechanisms for transmitting reference signals via a meta-surface. A method is performed by a network node. The network node serving user equipment via at least one meta-surface over a radio propagation channel. The method comprises defining a set of reference signal indices based on number of beams in which a reference signal is to be transmitted and number of meta-surface configurations applicable to the at least one meta-surface. Each of the meta-surface configurations represents a respective set of phase shifts as applied at the at least one meta-surface. The method comprises defining a mapping between the reference signal indices and the beams. The mapping defines which of the reference signal indices to be transmitted in which of the beams. The method comprises transmitting, in the beams and according to the mapping, the reference signal with the reference signal indices over the radio propagation channel.

### TECHNICAL FIELD

Embodiments presented herein relate to methods, a network node, a meta-surface controller, computer programs, and a computer program product for transmitting reference signals via a meta-surface.

### BACKGROUND

Millimeter waves (mmWaves) corresponding to carrier frequencies above 10 GHz have been introduced for the new radio (NR) air interface as used in fifth generation (5G) telecommunication systems. However, communication over mmWaves, as well as communication over carrier frequencies in lower bands, are sensible to blocking, i.e. physical objects blocking the radio waves.

One technique enabling the creation of smart radio environments involves the use of surfaces that can interact with the radio environment. As disclosed in, for example, “Smart Radio Environments Empowered by AI Reconfigurable Meta-Surfaces: An Idea Whose Time Has Come” by Marco Di Renzo et al., as accessible on https://arxiv.org/abs/1903.08925 (latest accessed 6 Jul. 2021), “Reconfigurable-Intelligent-Surface Empowered Wireless Communications: Challenges and Opportunities” by Xiaojun Yuan et al., as accessible on https://arxiv.org/abs/2001.00364 (latest accessed 6 Jul. 2021), and “Intelligent Reflecting Surface Enhanced Wireless Network via Joint Active and Passive Beamforming” by Q. Wu and R. Zhang, in IEEE Transactions on Wireless Communications, vol. 18, no. 11, pp. 5394-5409, November 2019, doi: 10.1109/TWC.2019.2936025 such surfaces are commonly called meta-surfaces, reconfigurable intelligent surfaces, large intelligent surfaces, or intelligent reconfigurable surfaces. Without loss of generality or discrimination between these terms, the term meta-surface will be used throughout this disclosure.

A meta-surface is an electromagnetic surface made of electromagnetic material that is engineered in order to exhibit properties that are not found in naturally occurring materials. A meta-surface is, in practice, an electromagnetic discontinuity, which can be defined as a complex electromagnetic structure that is typically deeply sub-wavelength in thickness, is electrically large in transverse size, and is composed of sub-wavelength scattering particles with extremely small features. In simple terms, a meta-surface is made of a two-dimensional array of sub-wavelength metallic or dielectric scattering particles that transform incoming electromagnetic waves in different ways, thus causing the electromagnetic waves to be reflected in accordance with the structure of the meta-surface.

In further detail, a passive meta-surface is a meta-surface in which the scattering particles or the electromagnetic reflective properties are not fixed and engineered at the manufacturing phase but can be modified depending on external stimuli that is provided to the meta-surface. In this disclosure the external stimuli is defined by a control signal from a reflection node that is operatively connected to the meta-surface. In one example the passive meta-surface consists of arrays of passive patch antennas. That is, the antennas are not connected to active radio transceivers (i.e., devices capable to modulate data streams up to radio frequency and demodulate radio frequencies to data streams). Instead, the antennas in the array are connected to resistors, inductors, and/or capacitors of which the electrical impedance is controllable, and where the antennas are connected to the resistors, inductors, and/or capacitors towards a ground plane such that the reflection phase of respective antenna can be adapted based on electrical impedance setting. Thus, by controlling the electrical impedances of the respective patch antennas, the reflection angle of an incoming electromagnetic wave can be adapted according to the generalized Snell's law. One difference between a regular surface and a passive meta-surface thus lies in the capability of the passive meta-surface of shaping, or reflecting, incoming electromagnetic waves, such as radio waves, according to the generalized Snell's laws of reflection and refraction. For example, the angles of incidence and reflection of the radio waves are not necessarily the same in a passive meta-surface.

One example use case of a fixedly mounted meta-surface is to mount the meta-surface to a wall of a building to enhance indoor coverage. This could be especially advantageous when the direct path from an indoor user equipment and its serving radio base station is relatively weak. Another example use case of a fixedly mounted meta-surface is in Integrated Access and Backhaul (IAB) networks, where meta-surfaces are placed outdoor in fixed locations to overcome blockage or tree foliage and help bypass signals from a parent IAB node to a child IAB node, or vice versa. In other example use cases, one or more meta-surfaces can be mounted to provide temporary network coverage extension for a group of user equipment within a geographical area of interest.

As a meta-surface can be implemented as a thin surface, this makes meta-surfaces portable. Further, the power consumption of a meta-surface might be negligible compared to that for a complete radio base station. Still further, the weight of a meta-surface can be much smaller than the combined weight of a complete radio base station plus its needed power supply. This makes it is easier to carry a meta-surface on a vehicle than a complete radio base station. For example, the meta-surface can be placed on an unmanned aerial vehicle (UAV). Even if this is also possible for some radio base stations, the UAV would typically have a longer flight time when carrying a meta-surface than when carrying a radio base station.

Turning now to the user side, before a user equipment can properly communicate with a network, the user equipment commonly must carry out a cell search to find, synchronize and identify a cell served by a network node. Then, the user equipment can acquire basic system information from the network node and perform a random access procedure with the network node to establish a connection to the network node and thus be served in the cell. In communication network using the NR air interface, the combination of synchronization signals (SS) and physical broadcast channel (PBCH) is referred to as a SS/PBCH block (SSB). Similar to communication networks in which the Long-Term Evolution (LTE) air interface is used, a pair of SS, primary synchronization signal (PSS) and secondary synchronization signal (SSS), is periodically transmitted in the downlink in each cell. This allows the user equipment to initially access to the network via the network node. By detecting the SS, a user equipment can obtain the physical cell identity, achieve downlink synchronization in both time and frequency, and acquire the timing for PBCH. PBCH carries the master information block (MIB), which contains a minimum system information that a user equipment is needing to acquire system information block 1 (SIB 1). SIB1 carries the remaining minimum system information that is needed for the user equipment to be able to perform the subsequent random-access procedure.

The initial access procedures used in both NR and LTE based communication networks handle the connection setup between a user equipment and a fixedly mounted network node based on radio resource control (RRC) messages communicated between the user equipment and the network node. However, existing initial access procedures do not address any of the above use cases where the user equipment is operatively connected to the network node via a meta-surface. The meta-surface is by itself not provided with any RRC functionalities but only acts as a reflector to change the propagation of radio signals between the network node and the user equipment in a controlled way. In addition, as noted above, a meta-surface is not necessarily fixedly mounted and thus can be carried on a movable vehicle (e.g., a truck, a UAV, a helicopter, a balloon), whose location can be changed occasionally over time. This makes it cumbersome to use initial access procedures in such scenarios.

### SUMMARY

An object of embodiments herein is to address the above issues by providing techniques that can be used as part of initial access in scenarios where a user equipment is to be served by a network node via a meta-surface.

In some aspects, the above issues are addressed by providing techniques for transmitting reference signals via a meta-surface. Such techniques can be used as part of initial access in scenarios where a user equipment is to be served by a network node via a meta-surface.

According to a first aspect there is presented a method for transmitting reference signals via a meta-surface. The method is performed by a network node. The network node serving user equipment via at least one meta-surface over a radio propagation channel. The method comprises defining a set of reference signal indices based on number of beams in which a reference signal is to be transmitted and number of meta-surface configurations applicable to the at least one meta-surface. Each of the meta-surface configurations represents a respective set of phase shifts as applied at the at least one meta-surface. The method comprises defining a mapping between the reference signal indices and the beams. The mapping defines which of the reference signal indices to be transmitted in which of the beams. The method comprises transmitting, in the beams and according to the mapping, the reference signal with the reference signal indices over the radio propagation channel.

According to a second aspect there is presented a network node for transmitting reference signals via a meta-surface. The network node is configured to serve user equipment via at least one meta-surface over a radio propagation channel. The network node comprises processing circuitry. The processing circuitry is configured to cause the network node to define a set of reference signal indices based on number of beams in which a reference signal is to be transmitted and number of meta-surface configurations applicable to the at least one meta-surface. Each of the meta-surface configurations represents a respective set of phase shifts as applied at the at least one meta-surface. The processing circuitry is configured to cause the network node to define a mapping between the reference signal indices and the beams. The mapping defines which of the reference signal indices to be transmitted in which of the beams. The processing circuitry is configured to cause the network node to transmit, in the beams and according to the mapping, the reference signal with the reference signal indices over the radio propagation channel.

According to a third aspect there is presented a network node for transmitting reference signals via a meta-surface. The network node is configured to serve user equipment via at least one meta-surface over a radio propagation channel. The network node comprises a define module configured to define a set of reference signal indices based on number of beams in which a reference signal is to be transmitted and number of meta-surface configurations applicable to the at least one meta-surface. Each of the meta-surface configurations represents a respective set of phase shifts as applied at the at least one meta-surface. The network node comprises a define module configured to define a mapping between the reference signal indices and the beams. The mapping defines which of the reference signal indices to be transmitted in which of the beams. The network node comprises a transmit module configured to transmit, in the beams and according to the mapping, the reference signal with the reference signal indices over the radio propagation channel.

According to a fourth aspect there is presented a computer program for transmitting reference signals via a meta-surface, the computer program comprising computer program code which, when run on processing circuitry of a network node, causes the network node to perform a method according to the first aspect.

In some aspects, the above issues are addressed by providing further techniques for transmitting reference signals via a meta-surface. Such further techniques can be used as part of initial access in scenarios where a user equipment is to be served by a network node via a meta-surface.

According to a fifth aspect there is presented a method for transmitting reference signals via a meta-surface. The method is performed by a meta-surface controller of the meta-surface. The method comprises controlling, at the meta-surface, reflection of a reference signal as received at the meta-surface from the network node over a radio propagation channel in accordance with meta-surface configurations applicable to the meta-surface. Each of the meta-surface configurations represents a respective set of phase shifts as applied at the meta-surface for controlling the reflection. Which meta-surface configuration to apply is defined by information obtained from the network node.

According to a sixth aspect there is presented a meta-surface controller for transmitting reference signals via a meta-surface. The meta-surface controller comprises processing circuitry. The processing circuitry is configured to cause the meta-surface controller to control, at the meta-surface, reflection of a reference signal as received at the meta-surface from the network node over a radio propagation channel in accordance with meta-surface configurations applicable to the meta-surface. Each of the meta-surface configurations represents a respective set of phase shifts as applied at the meta-surface for controlling the reflection. Which meta-surface configuration to apply is defined by information obtained from the network node.

According to a seventh aspect there is presented a meta-surface controller for transmitting reference signals via a meta-surface. The meta-surface controller comprises a control module. The control module is configured to control, at the meta-surface, reflection of a reference signal as received at the meta-surface from the network node over a radio propagation channel in accordance with meta-surface configurations applicable to the meta-surface. Each of the meta-surface configurations represents a respective set of phase shifts as applied at the meta-surface for controlling the reflection. Which meta-surface configuration to apply is defined by information obtained from the network node.

According to an eighth aspect there is presented a computer program for transmitting reference signals via a meta-surface, the computer program comprising computer program code which, when run on processing circuitry of a meta-surface controller, causes the meta-surface controller to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these methods, these network nodes, these meta-surface controllers, these computer programs, and this computer program product can be used as part of initial access in scenarios where a user equipment is to be served by a network node via a meta-surface.

Advantageously, these methods, these network nodes, these meta-surface controllers, these computer programs, and this computer program product enable the user equipment to establish an operative connect to the network node via a single meta-surface or multiple distributed meta-surfaces.

Advantageously, these methods, these network nodes, these meta-surface controllers, these computer programs, and this computer program product can be used as an extension to existing initial access procedures. In turn, this enables exiting initial access procedures to be reused, which reduces the cost and complexity of implementation of the herein disclosed embodiments.

Advantageously, these methods, these network nodes, these meta-surface controllers, these computer programs, and this computer program product are transparent to the user equipment. That is, whether the user equipment is operatively connected to the network node via one or more meta-surfaces or not is transparent to the user equipment. In turn, this makes it possible to completely reuse existing initial access procedures implemented at the user equipment side.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIGS. 1, 2, 3, and 7 are schematic diagrams illustrating communication networks according to embodiments;

FIGS. 4 and 5 are flowcharts of methods according to embodiments;

FIGS. 6, 8, 9, 10 is a schematic illustration of mappings between reference signal indices and combinations of beams and meta-surface configurations according to embodiments;

FIG. 11 is a schematic illustration of a mapping between reference signal indices and random access resources according to an embodiment;

FIG. 12 is a schematic diagram showing functional units of a network node according to an embodiment;

FIG. 13 is a schematic diagram showing functional modules of a network node according to an embodiment;

FIG. 14 is a schematic diagram showing functional units of a meta-surface controller according to an embodiment;

FIG. 15 is a schematic diagram showing functional modules of a meta-surface controller according to an embodiment; and

FIG. 16 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

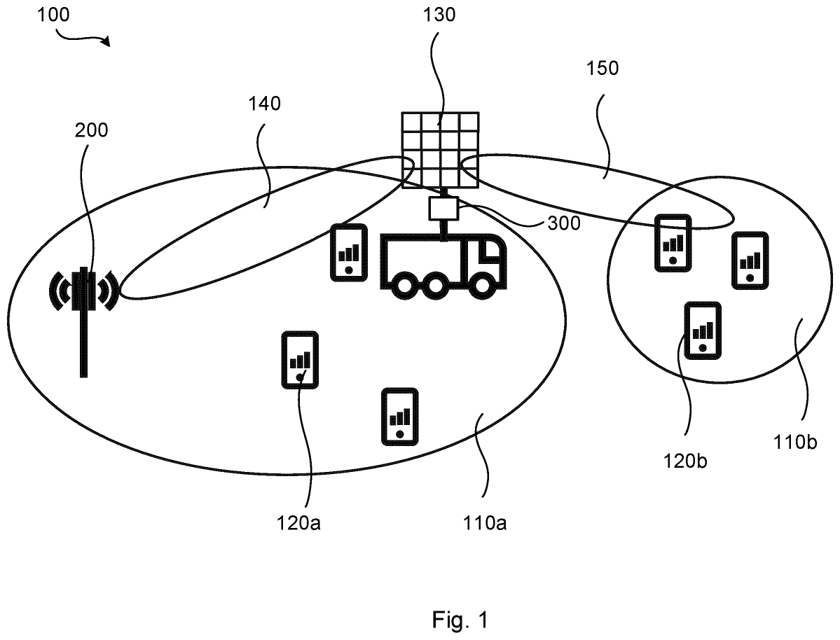

FIG. 1 is a schematic diagram illustrating a communication network 100 where embodiments presented herein can be applied. The communication network 100 comprises a network node 200 configured to provide network access to user equipment 120a within a cell 110a. The communication network 100 further comprises a meta-surface 130. In the non-limiting example of FIG. 1 the meta-surface 130 is illustrated as being movable by being carried by a vehicle in the form of a truck. The meta-surface 130 is configurable with different meta-surface configurations. Each meta-surface configuration can be defined in terms of a respective phase matrix, @, which is formed by the phase shift value (or time-delay value) of each reflecting element of the meta-surface 130. If it is possible to control the amplify value of each reflecting element of the meta-surface 130, the parameters for doing so can also be included in the meta-surface configuration. That is, in some embodiments, the meta-surface 130 comprises reflective elements having a respective phase shift value, where each meta-surface configuration of the meta-surface 130 is defined by a respective phase matrix, and where the phase matrix for a given meta-surface configuration is formed by the phase shift values of each reflecting element for this given meta-surface configuration. The meta-surface 130 is controlled by a meta-surface controller 300. In general terms, the meta-surface controller 300 controls which meta-surface configuration to be time-wise applied at the meta-surface 130. Further details of how the meta-surface controller 300 is configured to control the meta surface 130 will be disclosed below. In general terms, the meta-surface controller 300 is configured to control the reflection angle of the meta-surface 130. In order to do so, a separate control channel is established between network node 200 and the meta-surface controller 300. The control channel is typically wirelessly established using any known cellular communication techniques using carrier frequencies below 6 GHZ, or any local wireless area network standard, such as WiFi, or other radio access technology used over unlicensed radio spectrum. However, the control channel could also be established over a wired medium, such as a fiber optical cable.

The network node 200 is configured to communicate with the user equipment 120a in beams, one of which is illustrated at reference numeral 140. The meta-surface reflects a signal transmitted in the beam 140 in a reflection beam 150. The meta-surface 150 is configured to reflect the signal transmitted in the beam 140 in the reflection beam 150 so that the reflection beam 150 spans a cell 110b. The cell 110b defines a geographical area of interest. User equipment 120b located in the geographical area of interest can thereby be served by the network node 200 even when located outside the cell 110a. The meta-surface 130 is thereby utilized to extend the coverage of the network node 200.

In some non-limiting examples, the network node 200 is any of a (radio) access network node, radio base station, base transceiver station, node B (NB), evolved node B (eNB), gNB, access point, access node, IAB node. In some non-limiting examples, each of the user equipment 120a, 120b is any of a portable wireless device, mobile station, mobile phone, handset, wireless local loop phone, smartphone, laptop computer, tablet computer, wireless modem, wireless sensor device. In some examples the user equipment 120b subscribe to a mission critical (MC) service.

By means of the meta-surface 130 with meta-surface configurations as controlled by the meta-surface controller 300, the meta-surface 130 can be utilized to reflect radio signals so that the network node 200 can communicate with the user equipment 120b in the cell 110b defining a geographical area of interest.

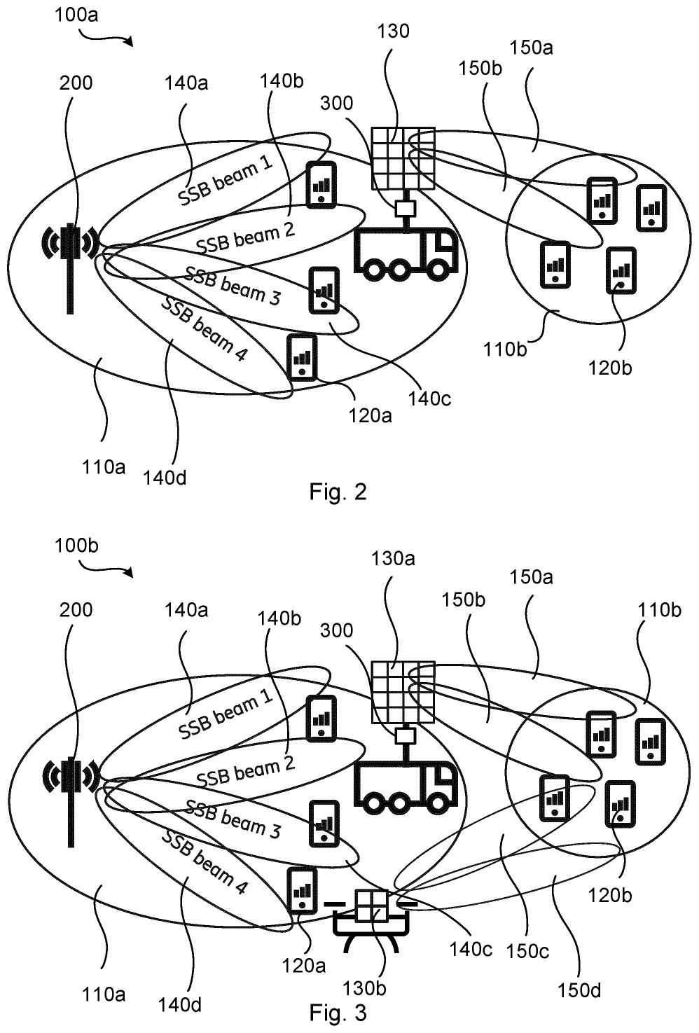

FIG. 2 shows the same communication network 100a as in FIG. 1 but where four beams 140a, 140b, 140c, 140d as used by the network node 200 for communication with the user equipment 120a, 120b are shown. In the illustrative example of FIG. 2, the network node 200 transmits a reference signal in each of the beams 140a:140d, with one reference signal index per beam. In some non-limiting examples, the reference signal is an SSB and then the beams might be referred to as SSB beams, and the reference signal indices as SSB indices. One respective SSB index is then transmitted in each SSB beam. As also illustrated in FIG. 2, each of SSB beam 1 and SSB beam 2 gives rise to its own reflection beam 150a, 150b at the meta-surface 130. SSB beam 3 and SSB beam 4 are illustrated to not reach the meta-surface 130.

FIG. 3 shows a similar communication network 100b as in FIG. 1 and FIG. 2 but where there are two meta-surfaces 130a, 130b. In the illustrative example of FIG. 2, the network node 200 is able to communicate with one of the meta-surfaces 130a in SSB beam 1 and SSB beam 2 and able to communicate with the other one of the meta-surfaces 130b in SSB beam 3 and SSB beam 4. As also illustrated in FIG. 3, each of SSB beam 1 and SSB beam 2 gives rise to its own reflection beam 150a, 150b at one of the meta-surfaces 130a and each of SSB beam 3 and SSB beam 4 gives rise to its own reflection beam 150c, 150d at the other one of the meta-surfaces 130b.

As disclosed above, there are some scenarios where it is cumbersome to perform initial access procedures when communicating via a meta-surface 130.

As further disclosed above, an object of embodiments herein is to address the above issues by providing techniques that can be used as part of initial access in scenarios where a user equipment is to be served by a network node via a meta-surface

The embodiments disclosed herein in particular relate to mechanisms for transmitting reference signals via a meta-surface 130, 130a, 130b and transmitting reference signals via a meta-surface 130, 130a, 130b. In order to obtain such mechanisms there is provided a network node 200, a method performed by the network node 200, a computer program product comprising code, for example in the form of a computer program, that when run on processing circuitry of the network node 200, causes the network node 200 to perform the method. In order to obtain such mechanisms there is further provided a meta-surface controller 300, a method performed by the meta-surface controller 300, and a computer program product comprising code, for example in the form of a computer program, that when run on processing circuitry of the meta-surface controller 300, causes the meta-surface controller 300 to perform the method.

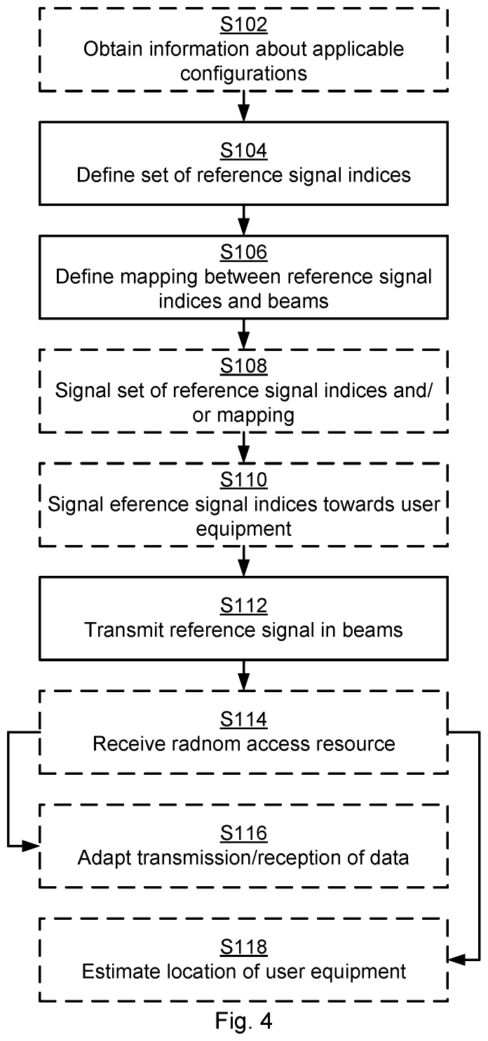

Reference is now made to FIG. 4 illustrating a method for transmitting reference signals via a meta-surface 130, 130a, 130b as performed by the network node 200 according to an embodiment. The network node 200 is configured to serve user equipment 120b via at least one meta-surface 130, 130a, 130b over a radio propagation channel.
S104: The network node 200 defines a set of reference signal indices based on number of beams 140, 140a:140d in which a reference signal is to be transmitted and number of meta-surface configurations applicable to the at least one meta-surface 130, 130a, 130b. Each of the meta-surface configurations represents a respective set of phase shifts as applied at the at least one meta-surface 130, 130a, 130b
S106: The network node 200 defines a mapping between the reference signal indices and the beams 140, 140a:140d. The mapping defines which of the reference signal indices to be transmitted in which of the beams 140, 140a:140d.
S112: The network node 200 transmits, in the beams 140, 140a:140d and according to the mapping, the reference signal with the reference signal indices over the radio propagation channel.

Embodiments relating to further details of transmitting reference signals via a meta-surface 130, 130a, 130b as performed by the network node 200 will now be disclosed.

The reference signal might be transmitted in one of the beams 140, 140a:140d at a time during a beam sweep in the beams 140, 140a:140d. Each of the reference signal indices might correspond to a respective reference signal time occasion. The reference signal might be an SSB. The reference signal might alternatively be a channel state information reference signal (CSI-RS). The type of reference signal that is used typically depends on the purpose. When the method is performed as part of an initial access procedure for the user equipment 120b, the reference signal is typically an SSB. When the method is performed as part of a beam management procedure for the user equipment 120b, the reference signal might be an SSB or a CSI-RS.

In case the location and/or the angle at which the meta-surface 130, 130a, 130b is deployed is adjusted, the association between reference signal indices and the combination of reference signal beams and meta-surface configurations may be updated so that it is optimized for the adjusted location and/or the angle. In case the number of reference signal indices (and the corresponding time occasions for transmitting these) is updated, then, all user equipment 120a, 120b might also be provided with this information via broadcast signalling from the network node 200, so that the user equipment 120a, 120b can update their operation accordingly.

In some aspects the network node 200 obtains information about which meta-surface configurations are applicable to the meta-surface 130, 130a, 130b. That is, in some embodiments, the network node 200 is configured to perform (optional) step S102.
S102: The network node 200 obtains information about which meta-surface configurations are applicable to the meta-surface 130, 130a, 130b.

There may be different ways for the network node 200 to obtain the information about which meta-surface configurations are applicable to the meta-surface 130, 130a, 130b. In some aspects, the information is received from the meta-surface controller 300. In other aspects, the information is received from another entity, such as a centralized network controller, a data repository, or the like.

In some aspects the network node 200 signals the reference signal indices towards the user equipment 120a, 120b for the user equipment 120a, 120b to use the reference signal indices during initial access. That is, in some embodiments, the network node 200 is configured to perform (optional) step S110.
S110: The network node 200 signals the reference signal indices towards the user equipment 120b.

Depending on the actual initial access procedure used by the user equipment 120a, 120b (and the network node 200), the reference signal indices might be signalled either prior to the network node 200 transmitting the reference signal or in conjunction with the network node 200 transmitting the reference signal. In this regard, the reference signal indices might be encoded in the transmission of the reference signal, for example when the reference signal is an SSB. But it is envisioned that for at least some other type of reference signals, the reference signal indices might not be encoded in the transmission of the reference signal.

In some aspects the network node 200 signals the set of reference signal indices and/or the mapping to the meta-surface controller 300. That is, in some embodiments, the network node 200 is configured to perform (optional) step S108.
S108: The network node 200 signals, to the meta-surface controller 300 of the at least one meta-surface 130, 130a, 130b and prior to transmitting the reference signal, at least one of: the set of reference signal indices and the mapping.

In some aspects the network node 200 repeatedly transmits the reference signal in each beam 140, 140a:140d for different reference signal indices between switching to another beam for transmission of the reference signals for other different reference signal indices. That is, in some embodiments, the reference signal is repeatedly transmitted for all reference signal indices mapped to one of the beams 140, 140a:140d before the reference signal is repeatedly transmitted for all reference signal indices mapped to another one of the beams 140, 140a:140d.

In some aspects the network node 200 only transmits the reference signal in beams 140, 140a:140d that can actually reach the meta-surface 130, 130a, 130b. That is, in some embodiments, the at least one meta-surface 130, 130a, 130b only is reachable by a subset of the beams 140, 140a:140d. The set of reference signal indices might then only be defined based on the number of beams 140, 140a:140d in the subset and the number of meta-surface configurations applicable to the at least one meta-surface 130, 130a, 130b. The mapping might then only be defined for the beams 140, 140a:140d in the subset, and the reference signal only be transmitted in the beams 140, 140a:140d in the subset.

In some aspects, as in the example of FIG. 3, there are at least two, or even multiple, meta-surfaces 130, 130a, 130b, each associated with its own subset of beams 140, 140a:140d. This enables the reference signal indices to be reused between the difference meta-surfaces 130, 130a, 130b. Particularly, in some embodiments, there are at least two meta-surfaces 130, 130a, 130b. Each of the at least two meta-surfaces 130, 130a, 130b is reachable by a respective subset of the beams 140, 140a:140d. A respective set of reference signal indices is defined for each of the at least two meta-surfaces 130, 130a, 130b.

In some aspects, the method is performed as part of an initial access procedure for the user equipment 120b. That is, in some embodiments, the reference signal is transmitted as part of an initial access procedure being performed by the network node 200. There might then be an association between the reference signal indices and random access resources. In particular, in some embodiments, each of the reference signal indices corresponds to a respective set of random access resources. The random access resources might be PRACH occasions and/or random access preamble indices. In turn, each PRACH occasion might be defined in terms of a time or/and frequency occasion to use for a random-access preamble transmission.

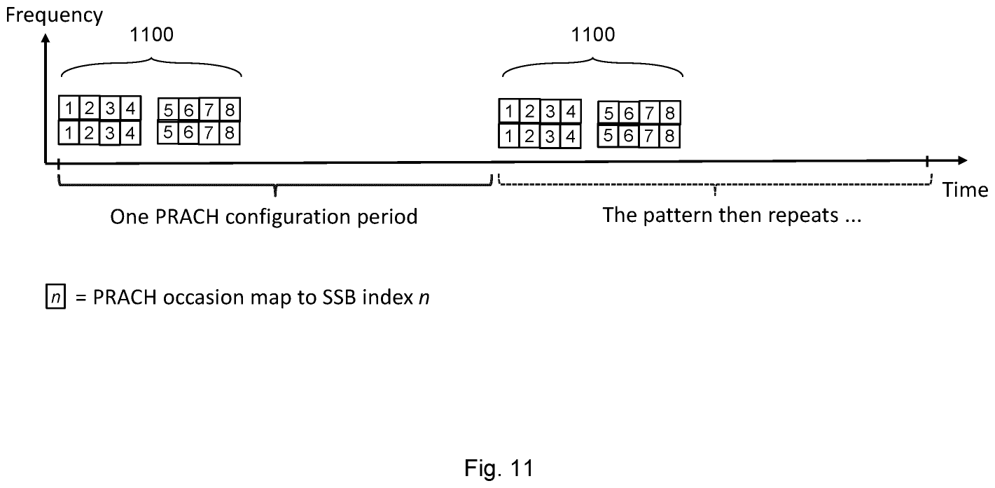

By detecting a random-access preamble transmitted from a user equipment 120b, the network node 200 can derive the information of which beam, which meta-surface and which meta-surface configuration was used by the user equipment for initial access. An example of this is shown in FIG. 11 which will be further described below. Particularly, in some embodiments, the network node 200 is configured to perform (optional) step S114.
S114: The network node 200 receives, from the user equipment 120b, a random access preamble in one of the random access resources. The random access resource is linked to one of the reference signal indices.

There could be different usage of the information of to which one of the reference signal indices the random access resource was linked.

In some aspects the network node 200 use the information to perform data transmission/receptions to/from the user equipment 120b. Particularly, in some embodiments, the network node 200 is configured to perform (optional) step S116.
S116: The network node 200 adapts transmission/reception of data with the user equipment 120b based on to which one of the reference signal indices the random access resource is linked.

In some aspects the network node 200 use the information for a coarse location estimation of the user equipment 120b 8 or even the meta-surface 130, 130a, 130b). Particularly, in some embodiments, the network node 200 is configured to perform (optional) step S118.
S118: The network node 200 estimates location of the user equipment 120b based on to which one of the reference signal indices the random access resource is linked.

In some aspects, the method is performed as part of a beam management procedure for the user equipment 120b. That is, in some embodiments, the reference signal is transmitted as part of a beam management procedure being performed by the network node 200. The beam management procedure is not necessarily an initial access procedure but a procedure performed by the network node 200 at regular intervals, such as periodically, in order to select the best beam pair link (BPL) for communication with the user equipment 120b after initial access.

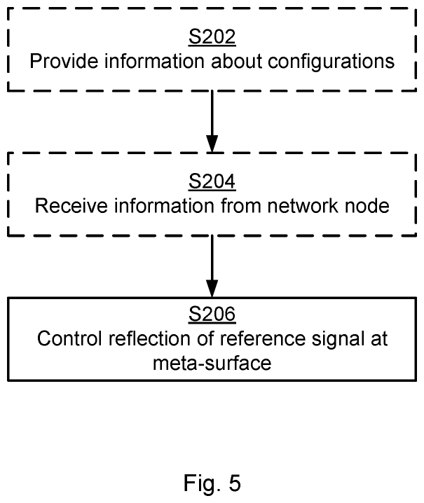

Reference is now made to FIG. 5 illustrating a method for transmitting reference signals via a meta-surface 130, 130a, 130b as performed by the meta-surface controller 300 according to an embodiment.
S206: The meta-surface controller 300 controls, at the meta-surface 130, 130a, 130b, reflection of a reference signal as received at the meta-surface 130, 130a, 130b from the network node 200 over a radio propagation channel. The refection is by the meta-surface controller 300 controlled in accordance with meta-surface configurations applicable to the meta-surface 130, 130a, 130b. Each of the meta-surface configurations represents a respective set of phase shifts as applied at the meta-surface 130, 130a, 130b for controlling the reflection. Which meta-surface configuration to apply is defined by information obtained from the network node 200.

Embodiments relating to further details of transmitting reference signals via a meta-surface 130, 130a, 130b as performed by the meta-surface controller 300 will now be disclosed.

As disclosed above, in some aspects the network node 200 signals the set of reference signal indices and/or the mapping to the meta-surface controller 300. Therefore, in some embodiments, the meta-surface controller 300 is configured to perform (optional) step S204.
S204: The meta-surface controller 300 receives, from the network node 200 and prior to controlling forwarding of the reference signal, the information.

As disclosed above, in some embodiments, the information comprises a set of reference signal indices based on the number of beams 140, 140a:140d in which the reference signal is to be transmitted and the number of meta-surface configurations applicable to the meta-surface 130, 130a, 130b.

As disclosed above, in some embodiments, the information comprises a mapping between the reference signal indices and the beams 140, 140a:140d, where the mapping defines which of the reference signal indices to be transmitted in which of the beams 140, 140a:140d.

As disclosed above, in some aspects the network node 200 obtains information about which meta-surface configurations are applicable to the meta-surface 130, 130a, 130b from the meta-surface controller 300. Therefore, in some embodiments, the meta-surface controller 300 is configured to perform (optional) step S202.
S202: The meta-surface controller 300 provides information about which meta-surface configurations are applicable to the network node 200.

Next will be disclosed one example method where the herein disclosed methods for transmitting reference signals via a meta-surface 130, 130a, 130b as performed by the network node 200 and the meta-surface controller 300 are applied in the context of initial access. In this example, the reference signals are exemplified by SSBs and hence the reference signal indices are SSB indices. Further, the beams in which the SSBs are transmitted are denoted SSB beams.
Step 1: A set of SSB indices are configured for the network node 200 based on the number of candidate combinations of its configured SSB beams and the meta-surface configurations. A mapping between an SSB index to a combination of an SSB beam of the network node 200 and meta-surface configuration is thus defined, and this mapping is thus made known at the network side. An association between the SSB indices and the random access resources used for initial access are also defined, and this association is made known at both the network node 200 and the user equipment 120b.
Step 2a: The SSB indices information is signaled from the network node 200 to all user equipment 120a, 120b in a broadcasted system information message, e.g., MIB or SIB1.
Step 2b: The SSB configuration information, or/and the SSB indices to meta-surface configuration mapping is signaled from the network node 200 to the meta-surface controller 300.
Step 3: A user equipment 120b receives the SSB indices information and uses this information together with the association between the SSB indices and the random access resources received from the system information message to perform contention based random access (CBRA) to access the network by transmitting a random-access preamble on PRACH.
Step 4: By detecting the random access preamble transmitted by the user equipment 120b, the network node 200 obtains the information about which combination of meta-surface configuration and SSB is selected by the user equipment 120b when accessing the network.
Step 5a: The network node 200 uses the received information when performing followed data transmission/receptions to/from the user equipment 300. For example, the information can by the network node 200 be used when selecting the beams to use for downlink data transmission to the user equipment 120b and uplink data reception from the user equipment 120b, or/and indicating the preferred meta-surface configuration to the meta-surface controller 300.
Step 5b: The network node 200 also uses the received information when performing a coarse location estimation of the user equipment 120b (and/or the meta-surface 130, 130a, 130b).

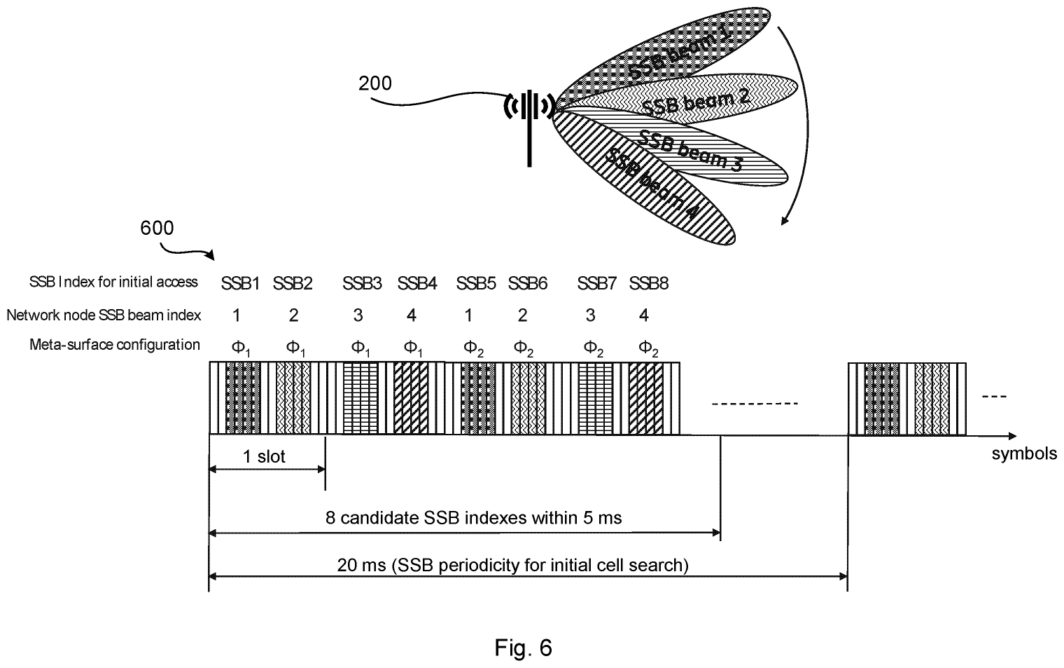

Next will with references to FIGS. 6, 7, 8, 9, and 10 be disclosed different examples of mappings between reference signal indices and beams 140, 140a:140d. The mappings define which of the reference signal indices to be transmitted in which of the beams 140, 140a:140d for the different meta-surface configurations. In these examples, the reference signals are exemplified by SSBs and hence the reference signal indices are SSB indices. Further, the beams in which the SSBs are transmitted are denoted SSB beams. Further, without loss of generality, the time window in which the user equipment is to perform an initial access is set to 20 ms. This time window thus corresponds to the SSB periodicity. Further, each SSB transmission performed within a periodicity is confined within 5 ms. These settings correspond to what is currently used in communication network based on the NR air interface. Using these settings makes it possible to completely reuse existing initial access procedures implemented at the user equipment side. However, the herein disclosed embodiments can be generalized for any other SSB configurations, e.g., with longer/shorter periodicity, and/or with transmissions of SSBs configured in other time windows.

Consider the scenario shown in FIG. 1, and assume that four SSB beams are configured at the network node 200 and that the meta-surface 130, 130a, 130b is configured with two meta-surface configurations (denoted by ϕ₁ and ϕ₂) to be used for assisting user equipment to perform initial access to connect to the network node 200.

One example mapping between SSB indices to use for initial access and the combinations of SSB beams and meta-surface configurations is shown at 600 in FIG. 6. As shown in FIG. 6, the total number of SSB indices configured for initial access is 8, which equals to the product of the number of SSB beams of the network node 200 (i.e., 4) and the number of meta-surface configurations (i.e., 2) for initial access. The eight SSB indices are mapped to eight different time occasions used for SSB transmissions from the network node 200. Within the SSB periodicity the network node 200 will transmit each of the four SSB beams twice. The network node 200 sweeps (according to the illustrated arrow) the four SSB beams twice within the SSB periodicity used for initial access, with each SSB sweeping associated to a specific meta-surface configuration.

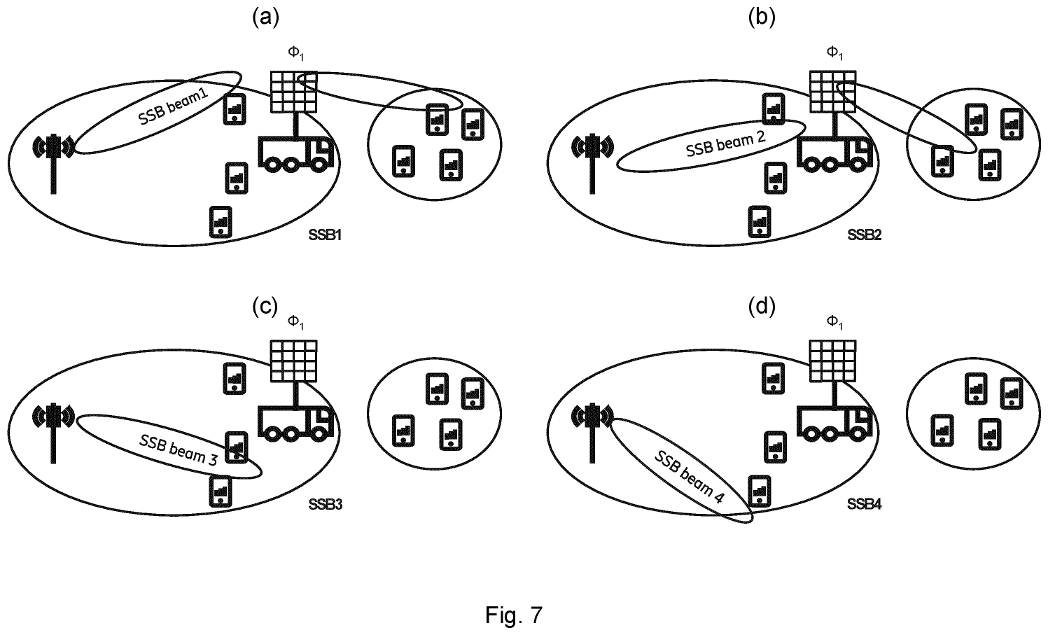

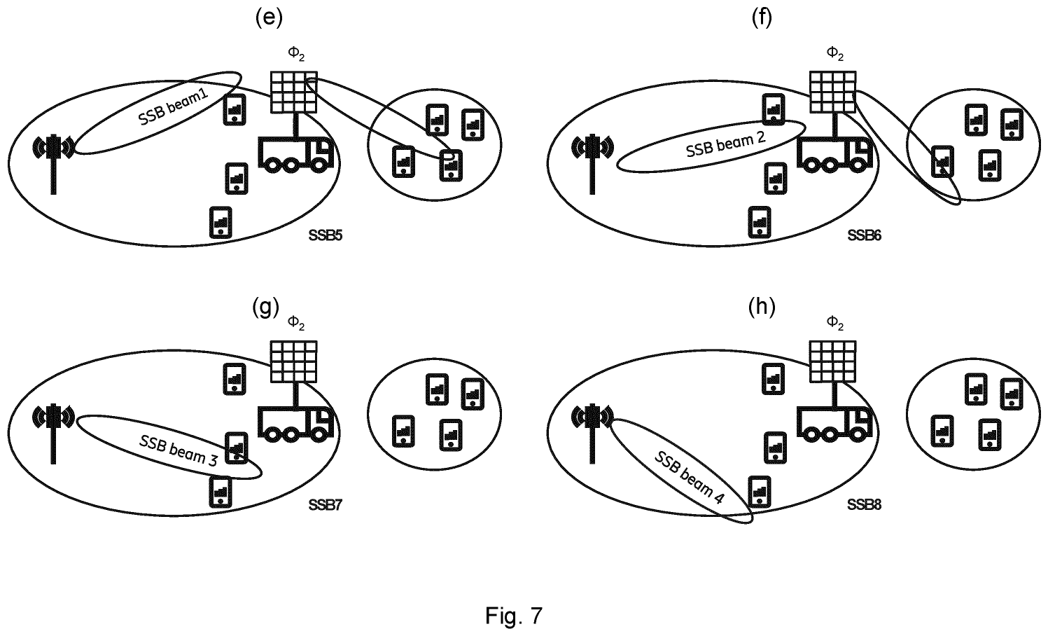

In FIG. 7 is illustrated in the order from (a) to (h) a time sequence of SSB transmissions in different SSB indices (or SSB time occasions) in the considered scenario in FIG. 1 and FIG. 2, when using the mapping defined in FIG. 6. Reference numerals have been excluded, but the illustrated components can be identified from their counterparts in FIG. 1 as well as in FIG. 2. As can be seen in FIG. 7 (as well as in FIG. 1 and FIG. 2), the meta-surface is placed at the cell-edge and is only capable to reflect SSBs transmitted using SSB beam 1 and SSB beam 2. When configured with different phase matrices (ϕ₁ and ϕ₂), the SSBs transmitted using the same beam (e.g., SSB beam 1) are reflected to point to different directions. That is, SSB beam 1 is reflected first for phase matrix ϕ₁ and then for phase matrix ϕ₂. Likewise, SSB beam 2 is reflected first for phase matrix ϕ₁ and then for phase matrix ϕ₂.

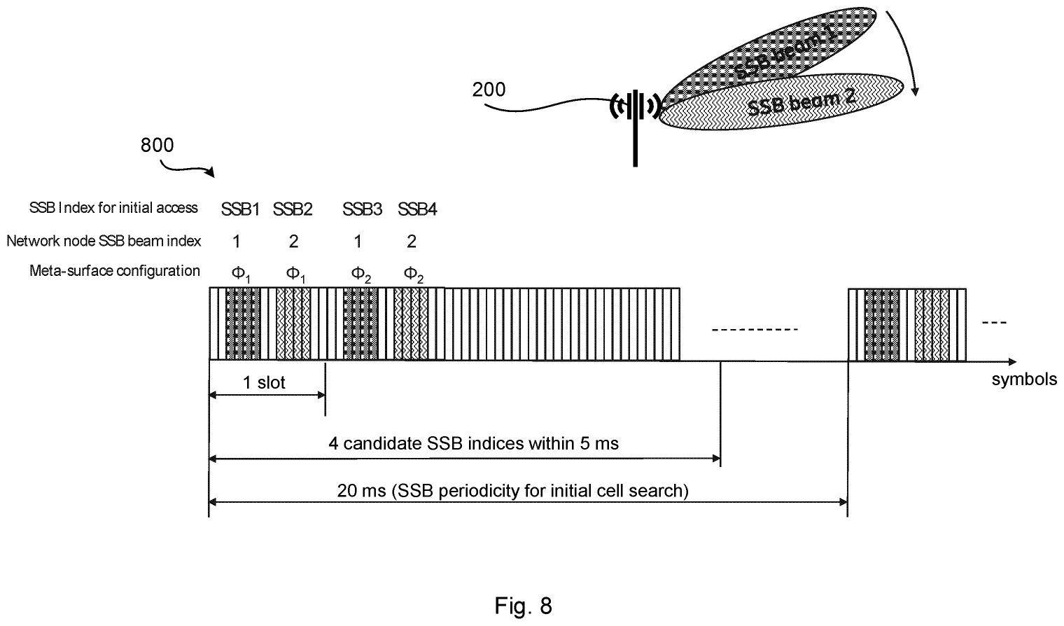

Another example mapping between SSB indices to use for initial access and the combinations of SSB beams and meta-surface configurations is shown at 800 in FIG. 8. This mapping can be used if the location of the meta-surface 130, 130a, 130b is known at the network side, and the connectivity for user equipment 120b in the geographical area of interest (e.g., mission critical user equipment 120b) should be prioritized comparing to other user equipment 120a. In this example the network node 200 only transmits the SSB in beams that can reach the meta-surface 130, 130a, 130b (e.g., SSB beam 1 and SSB beam 2 for the case shown in FIG. 7).

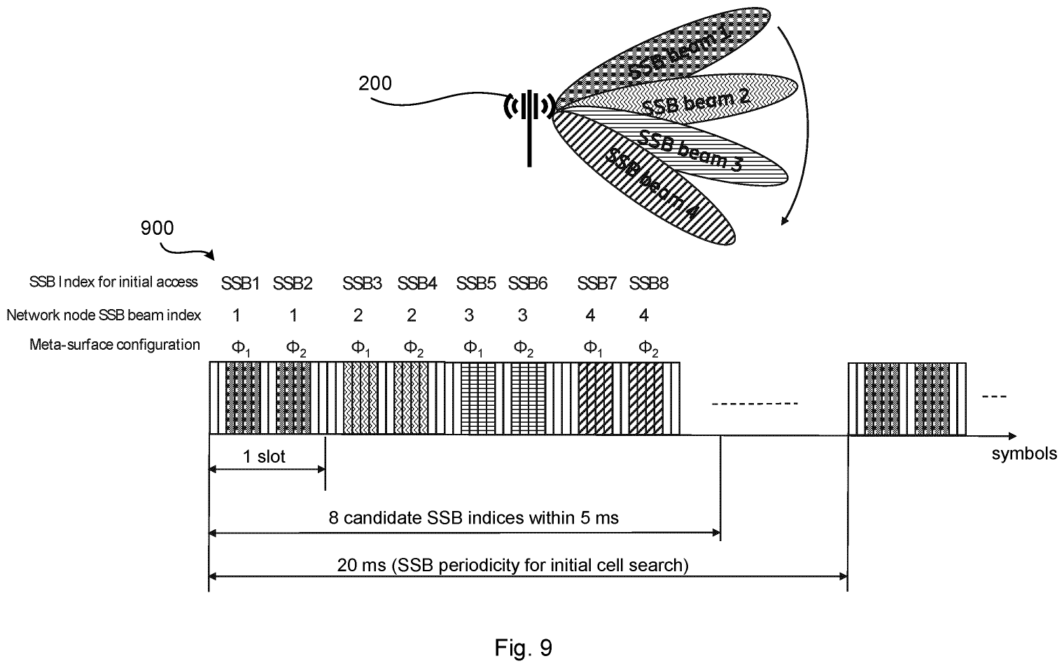

Another example mapping between SSB indices to use for initial access and the combinations of SSB beams and meta-surface configurations is shown at 900 in FIG. 9. According to this mapping the network node 200 repeats the transmission of one SSB beam twice, before sweeping to another SSB beam. The different SSB transmissions of a certain SSB beam are associated with different meta-surface configurations. This is of interest in scenarios where the location of the meta-surface 130, 130a, 130b is known at the network side and where the network node 200 thus does not need to transmit in any of SSB beam 5 to SSB beam 8.

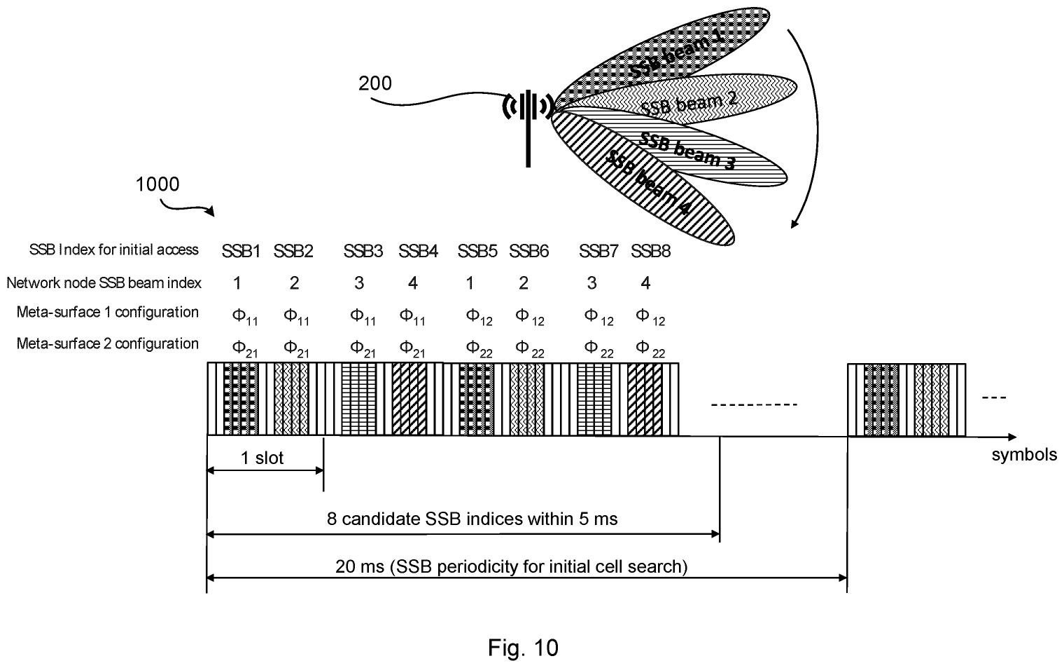

Another example mapping between SSB indices to use for initial access and the combinations of SSB beams and meta-surface configurations is shown at 1000 in FIG. 10. In this example, there are two meta-surfaces, as in the example of FIG. 3, where SSB beam 1 and SSB beam 2 are reflected at a first meta-surface (with phase matrices ϕ₁₁ and ϕ₁₂) and SSB beam 3 and SSB beam 4 are reflected at a second meta-surface (with phase matrices ϕ₂₁ and ϕ₂₂).

One example mapping between SSB indices and random access resources is shown at 1100 in FIG. 11. According to the NR air interface, each SSB index is associated with a set of valid PRACH occasions and a set of preambles. FIG. 11 shows an example where eight different SSB indices are mapped to different PRACH occasions. For a meta-surface, typically, only one meta-surface configuration can be applied per each time instance. Hence, the different meta-surface configurations need to be time-wise separately applied. That is why in the example figures different meta-surface configurations are mapped to different SSB indices in time. If beam correspondence is to be used for uplink reception, the random access resource association to different meta-surface configurations should also be separated in time. In some examples, the mapping between random access resources (as given by the reference signal indices) and the beams 140, 140a:140d is therefore defined such that different meta-surface configurations time-wise are associated with different random access resources.

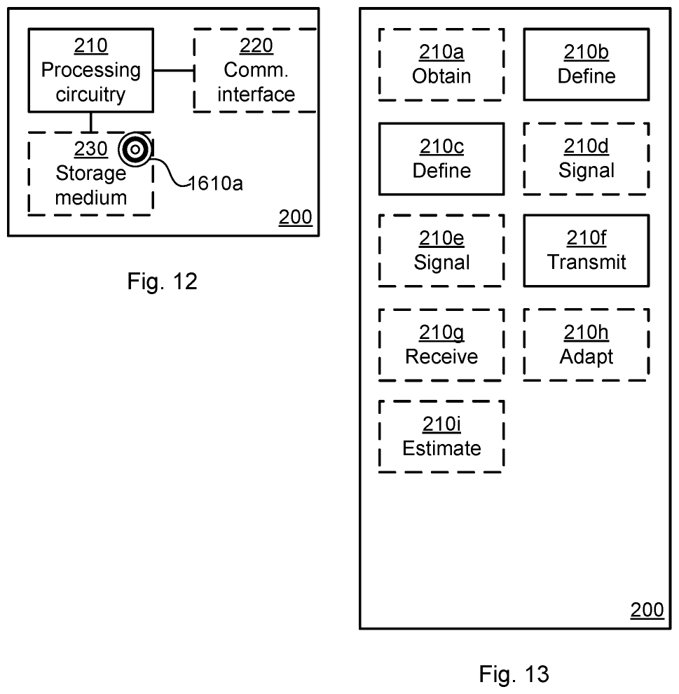

FIG. 12 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1610a (as in FIG. 16), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The network node 200 may further comprise a communications interface 220 for communications with other entities, functions, nodes, and devices, as for example illustrated in FIG. 1. As such the communications interface 220 may comprise one or more transmitters and receivers, comprising analogue and digital components.

The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 13 schematically illustrates, in terms of a number of functional modules, the components of a network node 200 according to an embodiment. The network node 200 of FIG. 13 comprises a number of functional modules; a define module 210b configured to perform step S104, a define module 210c configured to perform step S106, and a transmit module 210f configured to perform step S112. The network node 200 of FIG. 13 may further comprise a number of optional functional modules, such as any of an obtain module 210a configured to perform step S102, a signal module 210d configured to perform step S108, a signal module 210e configured to perform step S110, a receive module 210g configured to perform step S114, an adapt module 210h configured to perform step S116, and an estimate module 210i configured to perform step S118.

In general terms, each functional module 210a:210i may be implemented in hardware or in software. Preferably, one or more or all functional modules 210a:210i may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210i and to execute these instructions, thereby performing any steps of the network node 200 as disclosed herein.

The network node 200 may be provided as a standalone device or as a part of at least one further device. For example, the network node 200 may be provided in a node of a radio access network or in a node of a core network. Alternatively, functionality of the network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the network node 200 may be executed in a first device, and a second portion of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 12 the processing circuitry 210 may be distributed among a plurality of devices, or nodes. The same applies to the functional modules 210a:210i of FIG. 13 and the computer program 1620a of FIG. 16.

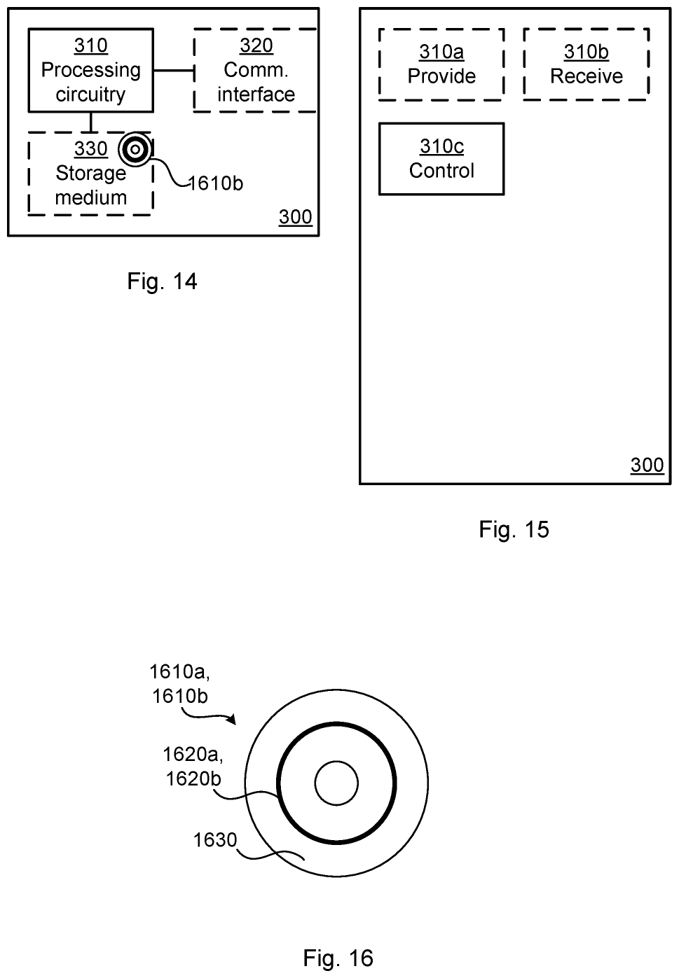

FIG. 14 schematically illustrates, in terms of a number of functional units, the components of a meta-surface controller 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1610b (as in FIG. 16), e.g. in the form of a storage medium 330. The processing circuitry 310 may further be provided as at least one application specific integrated circuit (ASIC), or field programmable gate array (FPGA).

Particularly, the processing circuitry 310 is configured to cause the meta-surface controller 300 to perform a set of operations, or steps, as disclosed above. For example, the storage medium 330 may store the set of operations, and the processing circuitry 310 may be configured to retrieve the set of operations from the storage medium 330 to cause the meta-surface controller 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The meta-surface controller 300 may further comprise a communications interface 320 for communications with other entities, functions, nodes and devices, and especially with the network node 200 and the meta-surface 130, 130a, 130b. As such the communications interface 320 may comprise one or more transmitters and receivers, comprising analogue and digital components.

The processing circuitry 310 controls the general operation of the meta-surface controller 300 e.g. by sending data and control signals to the communications interface 320 and the storage medium 330, by receiving data and reports from the communications interface 320, and by retrieving data and instructions from the storage medium 330. Other components, as well as the related functionality, of the meta-surface controller 300 are omitted in order not to obscure the concepts presented herein.

FIG. 15 schematically illustrates, in terms of a number of functional modules, the components of a meta-surface controller 300 according to an embodiment. The meta-surface controller 300 of FIG. 15 comprises a control module 310c configured to perform step S206. The meta-surface controller 300 of FIG. 15 may further comprise a number of optional functional modules, such as any of a provide module 310a configured to perform step S202, and a receive module 310b configured to perform step S204. In general terms, each functional module 310a:310c may be implemented in hardware or in software. Preferably, one or more or all functional modules 310a:310c may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310c and to execute these instructions, thereby performing any steps of the meta-surface controller 300 as disclosed herein.

FIG. 16 shows one example of a computer program product 1610a, 1610b comprising computer readable means 1630. On this computer readable means 1630, a computer program 1620a can be stored, which computer program 1620a can cause the processing circuitry 210 and thereto operatively coupled entities and devices, such as the communications interface 220 and the storage medium 230, to execute methods according to embodiments described herein. The computer program 1620a and/or computer program product 1610a may thus provide means for performing any steps of the network node 200 as herein disclosed. On this computer readable means 1630, a computer program 1620b can be stored, which computer program 1620b can cause the processing circuitry 310 and thereto operatively coupled entities and devices, such as the communications interface 320 and the storage medium 330, to execute methods according to embodiments described herein. The computer program 1620b and/or computer program product 1610b may thus provide means for performing any steps of the meta-surface controller 300 as herein disclosed.

In the example of FIG. 16, the computer program product 1610a, 1610b is illustrated as an optical disc, such as a CD (compact disc) or a DVD (digital versatile disc) or a Blu-Ray disc. The computer program product 1610a, 1610b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1620a, 1620b is here schematically shown as a track on the depicted optical disk, the computer program 1620a, 1620b can be stored in any way which is suitable for the computer program product 1610a, 1610b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for transmitting reference signals via a meta-surface, the method being performed by a network node, the network node serving user equipment via at least one meta-surface over a radio propagation channel, the method comprising:
defining a set of reference signal indices based on number of beams in which a reference signal is to be transmitted and number of meta-surface configurations applicable to the at least one meta-surface, wherein each of the meta-surface configurations represents a respective set of phase shifts as applied at the at least one meta-surface;
defining a mapping between the reference signal indices and the beams, wherein the mapping defines which of the reference signal indices to be transmitted in which of the beams; and
transmitting, in the beams and according to the mapping, the reference signal with the reference signal indices over the radio propagation channel.

2. The method of claim 1, wherein the method further comprises:
obtaining information about which meta-surface configurations are applicable to the meta-surface.

3. The method of claim 1, wherein the method further comprises:
signalling the reference signal indices towards the user equipment.

4. The method of claim 1, wherein the method further comprises:
signalling, to a meta-surface controller of the at least one meta-surface, and prior to transmitting the reference signal, at least one of: the set of reference signal indices and the mapping.

5. The method of claim 1, wherein the reference signal is repeatedly transmitted for all reference signal indices mapped to one of the beams before the reference signal is repeatedly transmitted for all reference signal indices mapped to another one of the beams.

6. The method of claim 1, wherein the at least one meta-surface only is reachable by a subset of the beams, wherein the set of reference signal indices only are defined based on number of beams in the subset and number of meta-surface configurations applicable to the at least one meta-surface, wherein the mapping only is defined for the beams in the subset, and wherein the reference signal only is transmitted in the beams in the subset.

7. The method of claim 1, wherein there are at least two meta-surfaces, wherein each of the at least two meta-surfaces is reachable by a respective subset of the beams, and wherein a respective set of reference signal indices is defined for each of the at least two meta-surfaces.

8-10. (canceled)

11. The method 10 claim 1, wherein
the reference signal is transmitted as part of an initial access procedure being performed by the network node, and the method further comprises:
receiving, from the user equipment, a random access preamble in one of the random access resources, wherein the random access resource is linked to one of the reference signal indices;
adapting transmission/reception of data with the user equipment based on to which one of the reference signal indices the random access resource is linked.

12. The method according to claim 1, wherein
the reference signal is transmitted as part of an initial access procedure being performed by the network node, and the method further comprises:
receiving, from the user equipment, a random access preamble in one of the random access resources, wherein the random access resource is linked to one of the reference signal indices;
estimating location of the user equipment based on to which one of the reference signal indices the random access resource is linked.

13. The method of claim 1, wherein the reference signal is transmitted as part of a beam management procedure being performed by the network node.

14-16. (canceled)

17. The method of claim 1, wherein the meta-surface comprises reflective elements having a respective phase shift value, and wherein each meta-surface configuration of the meta-surface is defined by a respective phase matrix, and wherein the phase matrix for a given meta-surface configuration is formed by the phase shift values of each reflecting element for said given meta-surface configuration.

18. A method for transmitting reference signals via a meta-surface, the method being performed by a meta-surface controller of the meta-surface, the method comprising:
controlling, at the meta-surface, reflection of a reference signal as received at the meta-surface from the network node over a radio propagation channel in accordance with meta-surface configurations applicable to the meta-surface, wherein each of the meta-surface configurations represents a respective set of phase shifts as applied at the meta-surface for controlling the reflection, and wherein which meta-surface configuration to apply is defined by information obtained from the network node.

19. The method of claim 18, wherein the method further comprises:
receiving, from the network node and prior to controlling forwarding of the reference signal, the information.

20. The method of claim 18, wherein the information comprises a set of reference signal indices based on number of beams in which the reference signal is to be transmitted and number of meta-surface configurations applicable to the meta-surface.

21. The method of claim 20, wherein
the information comprises a mapping between the reference signal indices and the beams, and wherein the mapping defines which of the reference signal indices to be transmitted in which of the beams, and
the method further comprises:
providing information to the network node about which meta-surface configurations are applicable.

22. (canceled)

23. The method of claim 18, wherein the meta-surface comprises reflective elements having a respective phase shift value, and wherein each meta-surface configuration of the meta-surface is defined by a respective phase matrix, and wherein the phase matrix for a given meta-surface configuration is formed by the phase shift values of each reflecting element for said given meta-surface configuration.

24. A network node for transmitting reference signals via a meta-surface, the network node being configured to serve user equipment via at least one meta-surface over a radio propagation channel, the network node comprising processing circuitry, the processing circuitry being configured to cause the network node to:
define a set of reference signal indices based on number of beams in which a reference signal is to be transmitted and number of meta-surface configurations applicable to the at least one meta-surface, wherein each of the meta-surface configurations represents a respective set of phase shifts as applied at the at least one meta-surface;
define a mapping between the reference signal indices and the beams, wherein the mapping defines which of the reference signal indices to be transmitted in which of the beams; and
transmit, in the beams and according to the mapping, the reference signal with the reference signal indices over the radio propagation channel.

25-26. (canceled)

27. A meta-surface controller for transmitting reference signals via a meta-surface, the meta-surface controller comprising processing circuitry, the processing circuitry being configured to cause the meta-surface controller to:
control, at the meta-surface, reflection of a reference signal as received at the meta-surface from the network node over a radio propagation channel in accordance with meta-surface configurations applicable to the meta-surface, wherein each of the meta-surface configurations represents a respective set of phase shifts as applied at the meta-surface for controlling the reflection, and wherein which meta-surface configuration to apply is defined by information obtained from the network node.

28-29. (canceled)

30. A non-transitory computer readable storage medium storing a computer program for configuring a network node to perform the method of claim 1.

31. A non-transitory computer readable storage medium storing a computer program for configuring a meta-surface controller to perform the method of claim 18.

32. (canceled)
